(19) United States
(12) Patent Application Publication
(10) Pub. No.: US 2007/0279018 A1
(43) Pub. Date: Dec. 6, 2007

(54) Power Supply Device and Electric Appliance Therewith

(75) Inventors: Hironori Sumitomo, Kyoto (JP); Yoshiyuki Hojo, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/756,245

(22) Filed: May 31, 2007

(30) Foreign Application Priority Data
Jun. 1, 2006 (JP) 2006-153047

(51) Int. Cl. G05F 1/613

(52) U.S. Cl. 323/224

(57) ABSTRACT

A power supply device has a DC/DC converter producing an intermediary voltage from an input voltage, a series regulator producing a desired output voltage from the intermediary voltage, an output current monitoring circuit monitoring the output current flowing through the series regulator, and an intermediary voltage adjustment circuit adjusting the feedback control of the DC/DC converter such that, as the monitored output current increases, the intermediary voltage increases and that, as the monitored output current decreases, the intermediary voltage decreases. This configuration offers high efficiency over the entire load range.

This application is based on Japanese Patent Application No. 2006-153047 filed on Jun. 1, 2006, the contents of which are hereby incorporated by reference.

### BACKGROUND OF THE INVENTION

1. Field of the Invention

The present invention relates to a power supply device that produces a desired output voltage from an input voltage, and to an electric appliance incorporating such a power supply device.

2. Description of Related Art

FIG. 7 is a circuit diagram showing an example of a conventional series regulator.

As shown in the figure, the conventional series regulator includes: an output transistor Tr connected in series between the node to which an input voltage Vi is applied and the node from which an output voltage Vo is derived; resistors Rx and Ry connected in series between the node from which the output voltage Vo is derived and the grounded node; and an amplifier ERR that produces the gate voltage of the output transistor Tr by amplifying the differential voltage between a feedback voltage Vfb derived from the node between the resistors Rx and Ry with a predetermined reference voltage Vref. Here, the desired output voltage Vo is produced from the input voltage Vi by controlling the conductance of the output transistor Tr in such a way as to keep the feedback voltage Vfb, which is commensurate with the output voltage Vo, equal to the reference voltage Vref.

The series regulator configured as described above, compared with switching regulators, produces less source-attributable ripples and noise and has a small circuit area, and is therefore widely used as means of power supply in portable appliances and the like that are susceptible to noise.

Inconveniently, however, with the series regulator configured as described above, the input-output potential difference (Vi−Vo) multiplied by the output current Io is completely lost. Thus, assuming that the output current Io remains constant, the higher the input-output voltage difference (Vi−Vo), the lower the efficiency η.

More specifically, when the input voltage Vi=3 V, the output voltage Vo=1 V, and the output current Io=100 mA, the loss in the output transistor Tr is (3−1) V×100 mA=200 mW; by contrast, when the input voltage Vi=5 V, the output voltage Vo=1 V, and the output current Io=100 mA, the loss in the output transistor Tr is (5−1) V×100 mA=400 mW. Thus, in this example, a so small an increase in the input voltage Vi from 3 V to 5 V results in doubling the loss in the output transistor Tr.

As a conventional technology related to what has been described above, JP-A-H06-245492 (hereinafter “Patent Document 1”) discloses and proposes a direct-current stabilized power supply circuit as shown in a simplified fashion in FIG. 8. Here, in the stage preceding a series regulator 200, a DC/DC converter 100 that produces from an input voltage Vi an intermediary voltage (as the input voltage to the series regulator 200) is inserted as means for keeping constant the input-output potential difference (Vp−Vo) across the series regulator 200.

As another conventional technology related to what has been described above, JP-A-H10-039937 (hereinafter “Patent Document 2”) discloses and proposes a power supply device that supplies drive electric power to a load device that includes a pulse load circuit that operates from direct-current power and produces a load current in the form of direct-current pulses. This power supply device includes: direct-current power generating means (a DC/DC converter circuit) for generating the direct-current power required by the load device; power delivering means for supplying the direct-current power generated by the just mentioned means to the load device; and voltage compensating means (a series regulator circuit), incorporated in the load device, for supplying the direct-current power from the direct-current power generating means to the pulse load circuit to compensate for variations in the drive voltage ascribable to the load current in the form of direct-current pulses generated in the pulse load circuit.

Certainly, with the direct-current stabilized power supply circuit of Patent Document 1, it is possible to keep constant the input-output potential difference across the series regulator 200 irrespective of variations in the input voltage Vi and the output voltage Vo. This helps achieve higher efficiency η than when the series regulator shown in FIG. 7 is used singly.

Inconveniently, however, in the direct-current stabilized power supply circuit of Patent Document 1, no consideration is given to the fact that the forward voltage drop Vdrop across the output transistor (=the on-state resistance Ron of the output transistor multiplied by the output current Io) included in the series regulator 200 varies with how heavy the load is (and hence how large the output current Io is).

More specifically, in the direct-current stabilized power supply circuit of Patent Document 1, the smaller the output current Io that flows through the output transistor in the series regulator 200, the smaller the forward voltage drop Vdrop across the output transistor; the larger the output current Io that flows through the output transistor, the higher the forward voltage drop Vdrop across it. Despite this, the input-output potential difference across the series regulator 200 is kept constant (e.g., 0.7 V).

Thus, so long as the output current Io is large, the direct-current stabilized power supply circuit of Patent Document 1 operates quite satisfactorily; in contrast, when the output current Io is small, the series regulator 200 is fed with an unnecessarily high voltage, hence the disadvantage of low efficiency η in a light-load condition.

On the other hand, according to the conventional technology of Patent Document 2, the purpose of arranging the series regulator near the load circuit is basically to eliminate the effect of variations in the direct-current voltage resulting from transient variations in the load current. Certainly this, compared with power supply devices including a DC/DC converter alone, helps improve the resistance to variations in the load current and helps increase the flexibility in the layout of the DC/DC converter. Like Patent Document 1, however, Patent Document 2 does not disclose or suggest anything about the lowering of efficiency η in a light-load condition or how to cope with it.

### SUMMARY OF THE INVENTION

An object of the present invention is to provide a power supply device that offers high efficiency over the entire load range, and to provide an electric appliance incorporating such a power supply device.

To achieve the above object, according to one aspect of the invention, a power supply device is provided with: a DC/DC converter that produces an intermediary voltage from an input voltage; a series regulator that produces a desired output voltage from the intermediary voltage; an output current monitoring circuit that monitors the output current that flows through the series regulator; and an intermediary voltage adjustment circuit that adjusts the feedback control of the DC/DC converter such that, as the monitored output current increases, the intermediary voltage increases and that, as the monitored output current decreases, the intermediary voltage decreases.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a block diagram showing an outline of the configuration of a cellular phone unit according to the invention;

FIG. 2 is a circuit diagram showing a power supply device 20 according to a first embodiment of the invention;

FIG. 3 is a circuit diagram showing an example of the intermediary voltage adjustment circuit 4;

FIG. 4 is a diagram showing the correlation between the output current Io and an intermediary voltage Vmo (≈Vmi);

FIG. 5 is a diagram showing the correlation between the output current Io and the efficiency η;

FIG. 6 is a circuit diagram showing a power supply device 20 according to a second embodiment of the invention;

FIG. 7 is a circuit diagram showing an example of a conventional series regulator; and

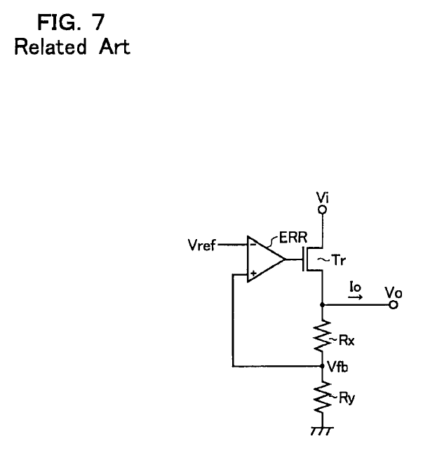

FIG. 8 is a block diagram showing an example of a conventional power supply device having a DC/DC converter inserted in the stage preceding a series regulator.

### DETAILED DESCRIPTION OF PREFERRED EMBODIMENTS

Hereinafter, the present invention will be described by way of examples in which it is applied to a power supply device incorporated in a cellular phone unit to produce a voltage for driving a load.

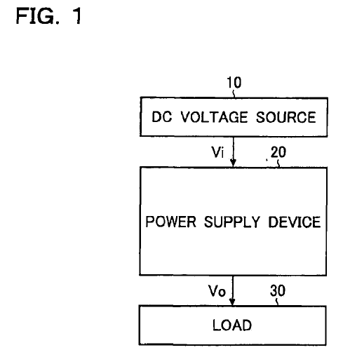

FIG. 1 is a block diagram showing an outline of the configuration of a cellular phone unit according to the invention (showing, in particular, the part concerned with the supply of electric power to a load).

As shown in the figure, the cellular phone unit of this embodiment includes: a direct-current voltage source 10 that produces an input voltage Vi; a power supply device 20 that produces from the input voltage Vi a desired output voltage Vo; and a load 30 that is driven with the output voltage Vo. Needless to say, the cellular phone unit of this embodiment further includes, though not illustrated in the figure, means for realizing its essential functions (such as communication functions), including a transmitter/receiver circuit, a loudspeaker, a microphone, a display, an operation panel, and a memory.

The direct-current voltage source 10 serves as means for producing a direct-current input voltage Vi, and is, in this embodiment, realized with a battery (e.g., a rechargeable battery such as an lithium-ion batter). The direct-current voltage source 10 may be realized with, instead of a battery, an AC/DC converter that converts a commercially distributed alternating-current voltage into a direct-current voltage.

The power supply device 20 serves as means for producing a desired output voltage Vo from the input voltage Vi fed from the direct-current voltage source 10 and then feeding the output voltage Vo to the load 30.

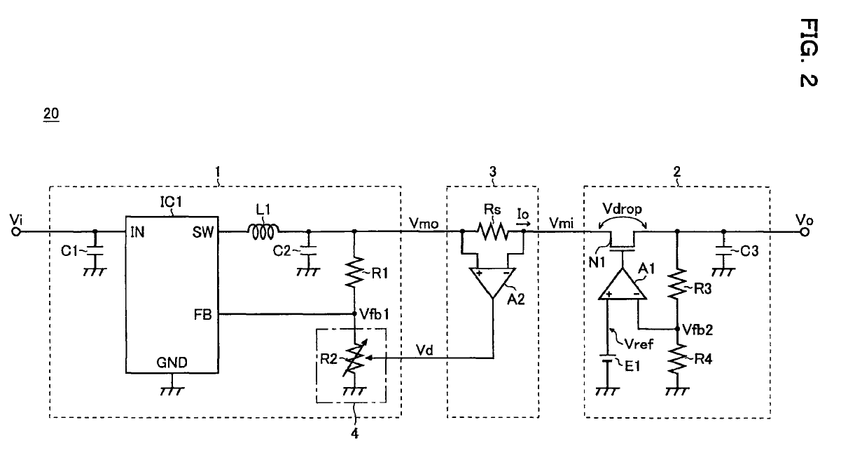

FIG. 2 is a circuit diagram (partly a block diagram) showing a power supply device 20 according to a first embodiment of the invention.

As shown in the figure, the power supply device 20 of this embodiment includes a DC/DC converter 1, a series regulator 2, an output current monitoring circuit 3, and an intermediary voltage adjustment circuit 4.

First, the configuration and operation of the DC/DC converter 1 will be described.

The DC/DC converter 1 includes a semiconductor integrated circuit device IC1, resistors R1 to R2, capacitors C1 and C2, and an inductor L1, and is configured as a step-down switching regulator (chopper regulator) that produces from the input voltage Vi an intermediary voltage Vmo.

The input terminal (IN) of the DC/DC converter 1 is connected to the node to which the input voltage Vi is applied, and is also connected via the capacitor C1, which is for input smoothing, to the grounded node. The switching terminal (SW) is connected to one end of the inductor L1. The other end of the inductor L1 serves as the node from which the intermediary voltage Vmo is derived; this end of the inductor L1 is connected via the output current monitoring circuit 3 to the series regulator 2, and is also connected to the grounded node via the capacitor C2, which is for output smoothing, and then the resistor division circuit composed of the resistors R1 to R2. The node between the resistors R1 to R2 serves as the node from which a feedback voltage Vfb1 (a division voltage obtained by dividing the intermediary voltage Vmo in a predetermined division ratio) whose voltage level varies according to the intermediary voltage Vmo is derived, and is connected to the feedback terminal (FB) of the semiconductor integrated circuit device IC1.

The semiconductor integrated circuit device IC1 is realized with a common semiconductor integrated circuit device for switching, and therefore its internal configuration is not specifically illustrated. For example, the semiconductor integrated circuit device IC1 may include an error amplifier that amplifies the differential voltage between the feedback voltage Vfb1 and a predetermined reference voltage and be so configured as to turn a switching transistor on and off in such a way as to decrease the output signal (error voltage) of the error amplifier. More specifically, the semiconductor integrated circuit device IC1 may be so configured as to produce a PWM (pulse width modulation) signal according to the result of comparison between the error voltage and a predetermined slope voltage (a triangular or ramp-shaped voltage) and turn a switching transistor on and off by use of the PWM signal.

As described above, in the stage preceding the series regulator 2, the DC/DC converter 1 is inserted that produces a stable intermediary voltage Vmo that is not affected by variations in the input voltage Vi. This helps obtain higher efficiency η than with the configuration in which the series regulator 2 is used singly.

Next, the configuration and operation of the series regulator 2 will be described.

The series regulator 2 includes an output transistor N1, resistors R3 and R4, a capacitor C3, an amplifier A1, and a direct-current voltage source E1, and serves as means for converting into a desired output voltage Vo an intermediary voltage Vmi (≈Vmo) fed via the output current monitoring circuit 3 from the DC/DC converter 1.

The series regulator 2 of this embodiment employs, as the output transistor N1, an N-channel field-effect transistor with a low forward voltage drop Vdrop, and is thus designed as a low drop-out regulator (called LDO regulator) that operates properly even when the intermediary voltage Vmi is only slightly higher than the desired output voltage Vo.

The drain of the output transistor N1 is connected to the node to which the intermediary voltage Vmi is applied. The source of the output transistor N1 serves as the node from which the output voltage Vo is derived; the source of the output transistor N1 is connected to the load 30 (unillustrated), and is also connected to the grounded node via the capacitor C3, for output smoothing, and then the resistor division circuit composed of the resistors R3 and R4. The node between the resistors R3 and R4 serves as the node from which a feedback voltage Vbf2 (a division voltage obtained by dividing the output voltage Vo in a predetermined division ratio) whose voltage level varies according to the output voltage Vo is derived, and is connected to the inverting input terminal (−) of the amplifier A1. The non-inverting input terminal (+) of the amplifier A1 is connected to the positive terminal (at which a reference voltage Vref is present) of the direct-current voltage source E1. The negative terminal of the direct-current voltage source E1 is connected to the grounded node. The output terminal of the amplifier A1 is connected to the gate of the output transistor N1.

In the series regulator 2 configured as described above, the amplifier A1 produces the gate voltage of the output transistor N1 in such a way as to keep the feedback voltage Vbf2 applied to its inverting input terminal (−) equal to the reference voltage Vref applied to its non-inverting input terminal (+).

Specifically, while the feedback voltage Vbf2 is lower than the reference voltage Vref, the amplifier A1 keeps the gate voltage of the output transistor N1 high; by contrast, when the feedback voltage Vfb2 is equal to or higher than the reference voltage Vref, the amplifier A1 controls the gate voltage of the output transistor N1 such that, the larger the deviation of the feedback voltage Vbf2 from the reference voltage Vref is, and thus the further the output voltage Vo is higher than its target level, the more the gate voltage of the output transistor N1 is decreased.

On the other hand, the conductance of the output transistor N1 is controlled according to its gate voltage fed from the amplifier A1. Thus, in the series regulator 2, the conductance of the output transistor N1 is controlled in such a way as to keep the feedback voltage Vbf2 equal to the reference voltage Vref, and hence to keep the output voltage Vo equal to its target level.

As described above, as means for ultimately producing the output voltage Vo, the series regulator 2 configured as described above is used. This helps minimize source-attributable ripples and noise contained in the output voltage Vo.

Next, the configuration and operation of the output current monitoring circuit 3 will be described.

The output current monitoring circuit 3 includes a sense resistor Rs and an amplifier A2, and functions as means for monitoring the output current Io that flows through the series regulator 2.

The sense resistor Rs is connected in serial between the DC/DC converter 1 and the series regulator 2. The non-inverting input terminal (+) of the amplifier A2 is connected to one end (higher-potential end) of the sense resistor Rs, and the inverting input terminal (−) of the amplifier A2 is connected to the other end (lower-potential end) of the sense resistor Rs. Thus, the monitoring voltage Vd outputted from the amplifier A2 increases as the output current Io increases, and decreases as the latter decreases.

Next, the configuration and operation of the intermediary voltage adjustment circuit 4 will be described.

The intermediary voltage adjustment circuit 4 of this embodiment serves as means for adjusting the voltage level of the feedback voltage Vfb1 by varying the resistance of the resistor R2 (and hence the voltage division ratio of the resistor division circuit composed of the resistors R1 to R2) according to the monitored output current Io (i.e., the monitoring voltage Vd).

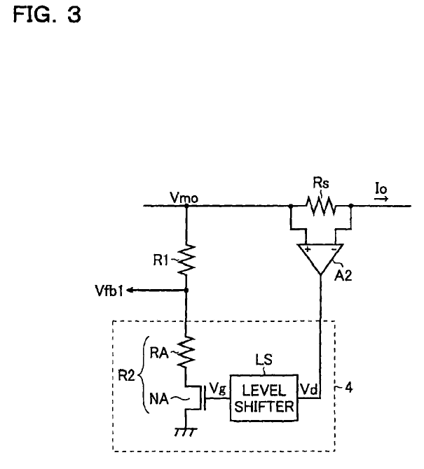

FIG. 3 is a circuit diagram (partly a block diagram) showing an example of the intermediary voltage adjustment circuit 4.

As shown in FIG. 3, in the intermediary voltage adjustment circuit 4 of this embodiment, the resistor R2 shown in FIG. 2 is realized with a resistor RA (having a constant resistance) connected in series with an N-channel field-effect transistor NA; in addition, a level shifter LS is provided as means for producing the gate voltage Vg of the transistor NA from the monitoring voltage Vd.

In the intermediary voltage adjustment circuit 4 configured as described above, as the monitoring voltage Vd fed from the output current monitoring circuit 3 increases, the gate voltage Vg of the transistor NA increases, and thus the impedance of the transistor NA (and hence the resistance of the resistor R2) decreases, causing the feedback voltage Vfb1 to decrease. Thus, the DC/DC converter 1 is feedback-controlled such that the intermediary voltage Vmo increases.

By contrast, as the monitoring voltage Vd fed from the output current monitoring circuit 3 decreases, the gate voltage Vg of the transistor NA decreases, and thus the impedance of the transistor NA (and hence the resistance of the resistor R2) increases, causing the feedback voltage Vfb1 to increase. Thus, the DC/DC converter 1 is feedback-controlled such that the intermediary voltage Vmo decreases.

In this way, the intermediary voltage adjustment circuit 4 configured as described above functions as means for adjusting the feedback control of the DC/DC converter 1 in such a way that, the larger the output current Io monitored by the output current monitoring circuit 3 is, the intermediary voltage Vmo is increased and that, the smaller the output current Io monitored is, the intermediary voltage Vmo is decreased.

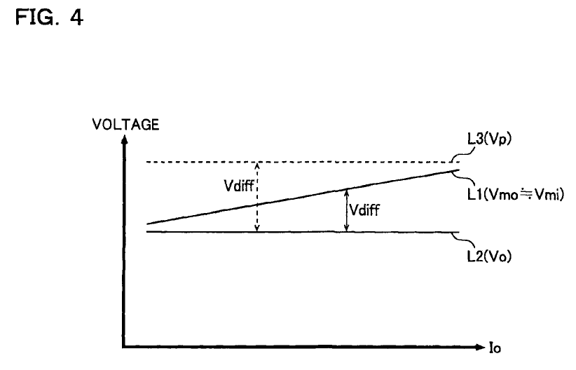

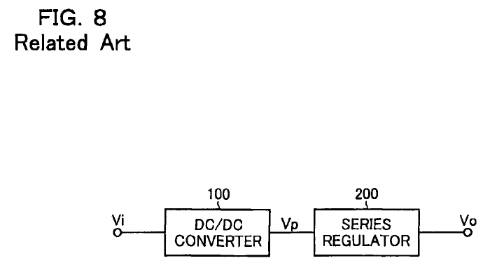

FIG. 4 is a diagram showing the correlation between the output current Io and the intermediary voltage Vmo (≈Vmi). In the figure, solid line L1 represents the behavior of the intermediary voltage Vmo, and solid line L2 represents the behavior of the output voltage Vo; for comparison, broken line L3 represents the intermediary voltage Vp (see FIG. 8) in the conventional configuration.

As will be understood from FIG. 4, with the configuration (see solid line L1) in which the intermediary voltage adjustment circuit 4 is provided to adjust the feedback control of the DC/DC converter 1 as described above, unlike the conventional configuration (see broken line L3) in which the input-output potential difference Vdiff (=Vmi−Vo) of the series regulator 2 is kept constant, it is possible to avoid feeding an unnecessarily high intermediary voltage Vmi to a series regulator 2, especially when the output current Io is small.

Put in more ideal terms, it is possible to feed the minimum necessary intermediary voltage Vmi to the series regulator 2 by adjusting the feedback control of the DC/DC converter 1 by making the level shifter LS produce the optimal gate voltage Vg such that the intermediary voltage Vmo (≈Vmi) is so produced to be higher than the output voltage Vo by the forward voltage drop Vdrop across the output transistor N1, in other words, such that the input-output potential difference Vdiff of the series regulator 2 is kept equal to the forward voltage drop Vdrop across the output transistor N1.

Incidentally, the forward voltage drop Vdrop across the output transistor N1 included in the series regulator 2 can be calculated as the on-state resistance Ron (previously known) of the output transistor N1 multiplied by the output current Io. Thus, monitoring the output current Io with the sense resistor Rs amounts to monitoring the forward voltage drop Vdrop across the output transistor N1. Thus, the optimum level of the intermediary voltage Vmo to be produced by the DC/DC converter 1 can be determined solely on the result of monitoring of the output current Io.

As described above, unlike the conventional configuration in which the input-output potential difference Vdiff (=Vmi−Vo) across the series regulator 2 is kept constant, the power supply device 20 of this embodiment can produce an intermediary voltage Vmo (≈Vmi) that dynamically varies with variations in the output current Io. Thus, with the power supply device 20 of this embodiment, it is possible to obtain improved efficiency η in the device as a whole in a light-load condition, and hence to obtain high efficiency over the entire load range.

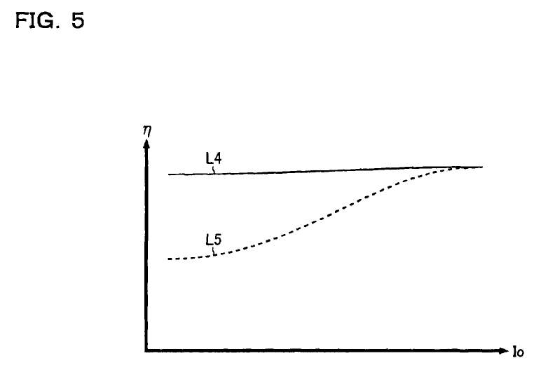

FIG. 5 is a diagram showing the correlation between the output current Io and the efficiency η. In the figure, solid line L4 represents the efficiency η as observed in the device as a whole when the invention is applied; for comparison, broken line L5 represents the efficiency η as conventionally observed.

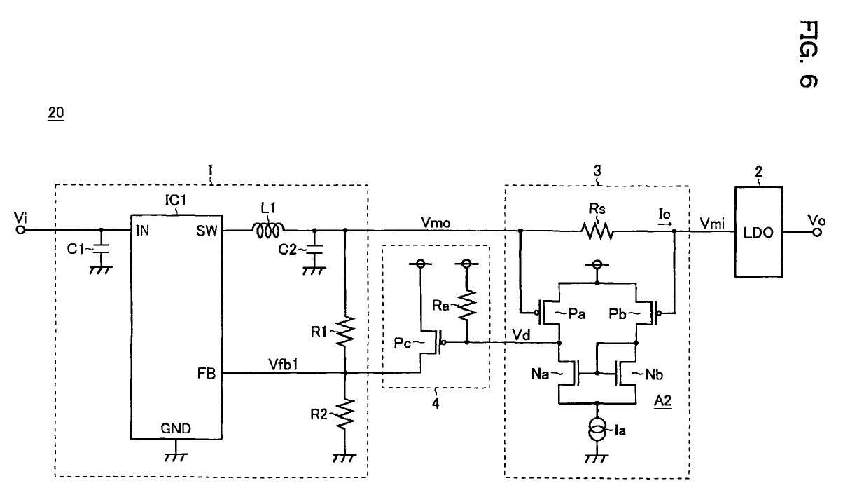

Now, a power supply device 20 according to a second embodiment of the invention will be described in detail with reference to FIG. 6.

FIG. 6 is a circuit diagram (partly a block diagram) showing the power supply device 20 according to the second embodiment.

As shown in the figure, the power supply device 20 of this embodiment has a configuration similar to that of the first embodiment described previously. Accordingly, such parts as find their counterparts in the first embodiment will be identified with common reference numerals and symbols, and their detailed explanation will not be repeated; thus, the following description proceeds with emphasis placed on the features unique to this embodiment (another example of the configuration of the intermediary voltage adjustment circuit 4).

As shown in FIG. 6, the intermediary voltage adjustment circuit 4 of this embodiment includes a P-channel field-effect transistor Pc and a resistor Ra.

The source of the transistor Pc is connected to a supplied power line (e.g., the node to which the input voltage Vi is applied). The drain of the transistor Pc is connected to the node between the resistors R1 to R2 (i.e., the node from which the feedback voltage Vfb1 is derived). The gate of the transistor Pc is connected via the resistor Ra to the supplied power line, and is also connected to the output terminal of the amplifier AZ.

The amplifier A2 includes P-channel field-effect transistors Pa and Pb, N-channel field-effect transistors Na and Nb, and a constant current source Ia.

The sources of the transistors Pa and Pb are both connected to the supplied power line. The gate of the transistors Pa is connected to one end (higher-potential end) of the sense resistor Rs. The gate of the transistors Pb is connected to the other end (lower-potential end) of the sense resistor Rs. The drain of the transistors Pa serves as the output terminal of the amplifier A2; the drain of the transistors Pa is connected to the drain of the transistor Na, and is also connected, as described previously, to the gate of the transistor Pc. The drain of the transistors Pb is connected to the drain of the transistor Nb. The gates of the transistors Na and Nb are connected together, and the node between them is connected to the drain of the transistor Nb. The sources of the transistors Na and Nb are both connected via the constant current source Ia to the grounded node.

In the intermediary voltage adjustment circuit 4 configured as described above, as the monitoring voltage Vd fed from the output current monitoring circuit 3 increases, the impedance of the transistor Pc increases, and thus the offset level (pull-up level) in the feedback voltage Vfb1 decreases. Thus, feedback control is performed such that the intermediary voltage Vmo increases.

By contrast, as the monitoring voltage Vd fed from the output current monitoring circuit 3 decreases, the impedance of the transistor Pc decreases, and thus the offset level (pull-up level) in the feedback voltage Vfb1 increases. Thus, feedback control is performed such that the intermediary voltage Vmo decreases.

In this way, as in the first embodiment, the intermediary voltage adjustment circuit 4 configured as described above functions as means for adjusting the feedback control of the DC/DC converter 1 in such a way that, the larger the output current Io monitored by the output current monitoring circuit 3 is, the intermediary voltage Vmo is increased and that, the smaller the output current Io monitored is, the intermediary voltage Vmo is decreased.

In the intermediary voltage adjustment circuit 4 configured as described above, the device size of the transistor Pc and the resistance of the resistor Ra (and hence the offset level (pull-up level) in the feedback voltage Vfb1) need to be adjusted appropriately such that the intermediary voltage Vmo (≈Vmi) is so produced to be higher than the output voltage Vo by the forward voltage drop Vdrop across the output transistor N1, in other words, such that the input-output potential difference Vdiff of the series regulator 2 is kept equal to the forward voltage drop Vdrop across the output transistor N1.

Configured as described above, the power supply device 20 of this embodiment can also produce an intermediary voltage Vmo (≈Vmi) that dynamically varies with variations in the output current Io. Thus, with the power supply device 20 of this embodiment, it is possible to obtain improved efficiency η in the device as a whole in a light-load condition, and hence to obtain high efficiency over the entire load range.

Although the embodiments described above deal with cases where the invention is applied to a power supply device in a cellular phone unit, this is in no way meant to limit the application of the invention; the invention finds wide application in power supply devices incorporated in electric appliances in general.

The invention may be practiced in any other manner than specifically described by way of embodiments above, and allows many modifications and variations within its spirit.

For example, although the embodiments described above deal with examples in which a step-down switching regulator is used as the DC/DC converter 1, this is in no way meant to limit how the invention is practiced; instead, a DC/DC converter of any other type may be used, such as a step-up switching regulator.

Although the embodiments described above deal with examples in which the intermediary voltage adjustment circuit 4 is so configured as to appropriately adjust the feedback voltage Vfb1 of the DC/DC converter 1, this is in no way meant to limit how the invention is practiced; instead, the intermediary voltage adjustment circuit 4 may be so configured as to appropriately adjust the target voltage with which the feedback voltage Vfb1 is compared in the DC/DC converter

Although the embodiments described above deal with examples in which the sense resistor Rs is connected in series with the output transistor N1, this is in no way meant to limit how the invention is practiced; instead, for example, a current monitoring transistor may be connected in parallel with the output transistor N1 so that the current that flows through the current monitoring transistor is monitored with the sense resistor Rs. With this configuration, since no sense resistor Rs is connected in series with the output transistor N1, it is possible to monitor the output current Io without increasing the on-state resistance of the device.

In terms of advantages, the invention helps realize power supply devices and electric appliances incorporating them that offer high efficiency over the entire load range.

In terms of industrial applicability, the invention is useful in improving the efficiency of direct-current stabilized power supply devices that produce a desired output voltage from an input voltage.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A power supply device comprising:
a DC/DC converter producing an intermediary voltage from an input voltage;
a series regulator producing a desired output voltage from the intermediary voltage;
an output current monitoring circuit monitoring an output current flowing through the series regulator; and
an intermediary voltage adjustment circuit adjusting feedback control of the DC/DC converter such that, as the monitored output current increases, the intermediary voltage increases and that, as the monitored output current decreases, the intermediary voltage decreases.

2. The power supply device according to claim 1,
wherein the intermediary voltage adjustment circuit adjusts the feedback control of the DC/DC converter such that the intermediary voltage is so produced as to be higher than the desire output voltage by a forward voltage drop across an output transistor included in the series regulator.

3. The power supply device according to claim 2,
wherein the DC/DC converter produces the intermediary voltage from the input voltage according to a feedback voltage whose voltage level varies with the intermediary voltage, and the intermediary voltage adjustment circuit adjusts the voltage level of the feedback voltage according to the monitored output current.

4. The power supply device according to claim 3,
wherein the feedback voltage is a division voltage obtained by dividing the intermediary voltage in a predetermined division ratio, and the intermediary voltage adjustment circuit adjusts the voltage level of the feedback voltage by varying the division ratio according to the monitored output current.

5. An electric appliance comprising:
a direct-current voltage source producing an input voltage;
a power supply device producing a desired output from the input voltage; and
a load driven with the output voltage,
wherein the power supply device comprises
a DC/DC converter producing an intermediary voltage from the input voltage;
a series regulator producing the desired output voltage from the intermediary voltage;
an output current monitoring circuit monitoring an output current flowing through the series regulator; and
an intermediary voltage adjustment circuit adjusting feedback control of the DC/DC converter such that, as the monitored output current increases, the intermediary voltage increases and that, as the monitored output current decreases, the intermediary voltage decreases.

6. The electric appliance according to claim 5,
wherein the intermediary voltage adjustment circuit adjusts the feedback control of the DC/DC converter such that the intermediary voltage is so produced as to be higher than the desire output voltage by a forward voltage drop across an output transistor included in the series regulator.

7. The electric appliance according to claim 6,
wherein the DC/DC converter produces the intermediary voltage from the input voltage according to a feedback voltage whose voltage level varies with the intermediary voltage, and the intermediary voltage adjustment circuit adjusts the voltage level of the feedback voltage according to the monitored output current.

8. The electric appliance according to claim 7,
wherein the feedback voltage is a division voltage obtained by dividing the intermediary voltage in a predetermined division ratio, and the intermediary voltage adjustment circuit adjusts the voltage level of the feedback voltage by varying the division ratio according to the monitored output current.
